(19) United States
(12) Patent Application Publication
(10) Pub. No.: US 2017/0129205 A1
(43) Pub. Date: May 11, 2017

(54) FOOTWEAR INSOLE AND MANUFACTURING METHOD THEREOF

(71) Applicant: Heedae Park, Busan (KR)

(72) Inventor: Heedae Park, Busan (KR)

(21) Appl. No.: 14/953,601

(22) Filed: Nov. 30, 2015

(30) Foreign Application Priority Data
Nov. 10, 2015 (KR) 10-2015-0157748

(51) Int. Cl. B32B 5/18; B32B 37/14; B32B 7/12

(52) U.S. Cl. CPC B32B 5/18; B32B 7/12; B32B 37/14; B32B 2250/02; B32B 2250/22; B32B 2250/24; B32B 2266/0278; B32B 2305/022; B32B 2437/02; B32B 2038/0084

(57) ABSTRACT

The present invention is to provide a thin foam skin having cushioning effect and the excellent grip performance without slip so as to substitute the fabric adhered to the top part of a footwear insole, and realize a footwear insole and a manufacturing method thereof, wherein the foam skin for substituting a fabric is preferably made using polyurethane resin so as to prevent the slip phenomenon when adhering the foam skin to the top part of an insole and smoothly absorb sweat by using the hydrophilic property, thereby maintaining pleasant wearing feeling all the time even during long time exercise.

### REFERENCE TO RELATED APPLICATIONS

This application claims the priority benefit of Korean Patent Application No. 10-2015-0157748 filed on Nov. 10, 2015, the entire contents of which are incorporated herein by reference.

### FIELD OF THE INVENTION

The present invention relates to a footwear insole and a manufacturing method thereof and, more specifically, to a footwear insole and a manufacturing method thereof, wherein a polyurethane foam skin which can substitute an insole fabric and then is adhered to the top part of an insole polyurethane foam, thereby improving cushioning effect, preventing a slip phenomenon and realizing excellent sweat absorbing property even during the long time wearing of such footwear, thereby maintaining pleasant wearing feeling for a long time.

### BACKGROUND OF THE INVENTION

As well known, footwear is to be put on feet of a human body for the protection of the feet and manufactured in various shapes and kinds to be sold. In general, such a footwear article includes an upper for covering the top and the ankle of a foot, and a sole for protecting a foot sole and increasing the frictional force with respect to the ground surface so as to improve walkability simultaneously with absorbing the shock applied to the foot sole during walking.

Such a footwear sole includes, in general, an insole to be an insert for a footwear article, a midsole formed of rubber or foamed resin or a sponge material, which has excellent shock-absorbing force, so as to elastically disperse and support the load of a human body during walking, and an outsole formed of a rubber material so as to be attached to the bottom surface of the midsole and apply frictional force.

Meanwhile, the insole is formed in the shape of a foam by foaming a polyurethane PU or ethylene-vinyl acetate EVA material, and then typically attached to a fabric by an adhesive or a hot melt film.

That is, a conventional footwear insole is processed using PU foam or EVA foam, as shown in FIG. 1, and then adhered to fabric on the upper part thereof, which comes into direct contact with the foot sole of a wearer in use.

However, the prior art footwear insole as above has a disadvantage that the wearing feeling thereof is not good since a foot is likely to slip on the fabric due to the slipperiness of the fabric when sweat is generated and the fabric gets damp. In addition, since the fabric itself has stiff feeling, the cushioning effect of the insole formed of foam is likely to be remarkably decreased, increasing a fatigue degree in the case of long time wearing.

In particular, the prior art insole has a disadvantage that the insole is adhered to the fabric on the top part thereof, as shown in FIG. 1, such that the sweat is hardly to be absorbed, thus involving unpleasant feeling in the long time exercise. Further, a wearer of footwear articles having such insoles inevitably feels much clammy with the sweat from the feet and this unpleasant feeling further increases in summer.

### SUMMARY OF THE INVENTION

Accordingly, the present invention has been made to solve the above-mentioned problems occurring in the prior arts, and it is an objective of the present invention to provide a polyurethane foam skin, which can substitute the fabric adhered to the top part of a footwear insole.

It is another objective of the present invention to provide a footwear insole and a manufacturing method thereof, wherein a polyurethane foam skin instead of adhering a fabric is adhered to the top part of a footwear insole so as to improve cushioning effect and prevent a slip phenomenon.

To accomplish the above objectives, according to the present invention, there is provided a method for manufacturing a footwear insole, comprising the steps of: producing polyurethane resin by using hydrophilic polyether polyols and then foaming thus produced polyurethane resin so as to prepare a polyurethane foam skin; and laminating-adhering the polyurethane foam and the polyurethane foam skin to each other by applying an adhesive between the polyurethane foam and the polyurethane foam skin so as to form a footwear insole.

The present invention has advantages that the polyurethane foam skin is adhered to the top part of the polyurethane foam instead of using a fabric when manufacturing a footwear insole, thereby improving cushioning effect and preventing the feet of a user from slipping in the footwear.

Further, according to the present invention, sweat can be smoothly absorbed while a user wears the footwear for a long time, thereby removing the unpleasant feeling from the sticking with sweat and maintaining pleasant feeling all the time. In addition, by using the insole to which the polyurethane foam skin is adhered, increased effect of maintaining pleasant wearing feeling during long time exercise.

### BRIEF DESCRIPTION OF THE DRAWINGS

The above and other objectives, features and advantages of the present invention will be apparent from the following detailed description of the preferred embodiments of the invention in conjunction with the accompanying drawings, in which:

FIG. 1 is a view showing the structure of a prior art footwear insole, to which a fabric is attached.

FIG. 2 is a view showing the structure of a footwear insole, to which a polyurethane foam skin is attached, according to a preferred embodiment of the present invention.

FIG. 3 is a view showing the overall shape of the footwear insole of FIG. 2 in detail, and

FIG. 4 is a cross-sectional view showing the structure of a footwear insole, to which a polyurethane foam skin is attached, according to another preferred embodiment of the present invention.

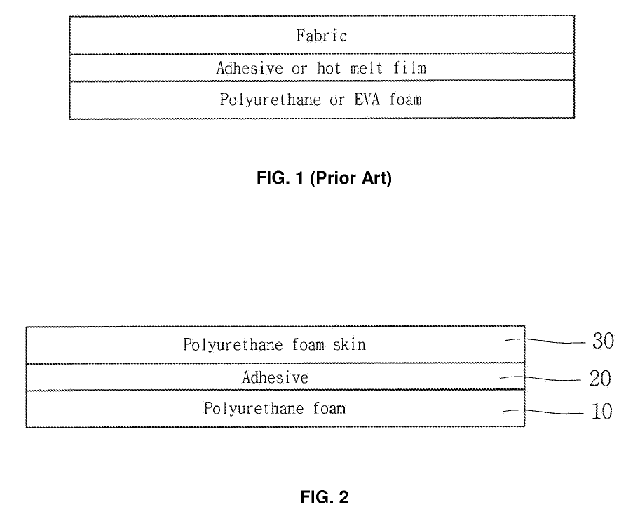

### BRIEF EXPLANATION OF REFERENCE SIGNS

10: polyurethane foam

20: adhesive

30: polyurethane foam skin

40: polyurethane resin coating layer

100: footwear insole.

### DETAILED DESCRIPTION OF THE INVENTION

Hereinafter, reference will be now made in detail to the preferred embodiments of the present invention with reference to the attached drawings. In the detailed description hereinbelow, a typical embodiment of the present invention will be provided in order to solve the above technical problems. The description of any other embodiments which could be suggested in the present invention will be substituted with the description of the features of the present invention.

The present invention is to provide a thin foam skin having cushioning effect and the excellent grip performance without slip so as to substitute a fabric adhered to the top part of a footwear insole, and realize a footwear and a manufacturing method thereof, wherein the foam skin for substituting a fabric is preferably made using polyurethane resin so as to prevent the slip phenomenon when adhering the foam skin to the top part of an insole and smoothly absorb sweat by using the hydrophilic property, thereby maintaining pleasant wearing feeling all the time even during long time exercise.

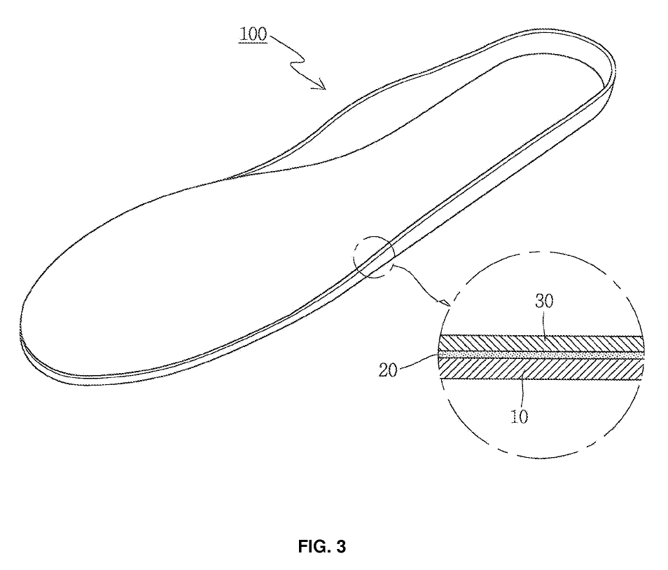

Hereinafter, the technical features of a footwear insole according to a preferred embodiment of the present invention and, more specifically, the technical features of a footwear insole to which a polyurethane foam skin is attached and a method for manufacturing such a polyurethane foam skin will be described in detail with reference to FIG. 2 and FIG. 3.

FIG. 2 and FIG. 3 are views showing features of a footwear insole, to which a polyurethane foam skin according to a preferred embodiment of the present invention is attached. A footwear insole 100 according to the present invention forms a polyurethane foam 10 formed according to a normal method, and a polyurethane foam skin 30 corresponding to an essential constituent element of the present invention is adhered to the top part of the polyurethane foam 10 by using an adhesive 20. Herein, it is preferable that the polyurethane foam 10 and the polyurethane foam skin 30 are adhered to each other by a laminating method.

Referring to FIG. 2 and FIG. 3, the polyurethane foam 10 is formed by a general foaming method, wherein it is preferable that the polyurethane foam 10 has a thickness of about 4-6 mm. In addition, it is preferable to use the adhesive 20 in the laminating method in order to apply air permeability.

Meanwhile, the polyurethane foam skin 30 according to the present invention is adhered to the top part of the general polyurethane foam 10 by the adhesive 20, wherein the polyurethane foam skin 30 is formed of a composition having excellent elasticity (cushioning effect) and grip performance. That is, the polyurethane foam skin 30 is formed of polyurethane resin, which is made using hydrophilic polyether polyols. If using such a composition, that is, the polyurethane resin formed of hydrophilic polyether polyols, it is possible to improve the cushioning effect owing to the high elasticity thereof, prevent the feet of a user from slipping in the footwear owing to the excellent grip performance, even though the user wears the footwear for a long time, and smoothly absorb sweat owing to the high hydrophilic property, thereby maintaining pleasant wearing feeling even during long time exercise.

By using the polyurethane foam skin 30 of the present invention instead of a fabric as described above, the grip performance becomes excellent comparing to the conventional fabric such that the feet are prevented from slipping in spite of sweat, the sweat can be readily absorbed owing to the excellent hydrophilic property, and the feet can be maintained comfortably owing to the characteristic elasticity. In particular, since the foam is used in the manufacturing of the footwear insole, that is, the insole is manufactured by adhering the polyurethane foam 10 and the polyurethane foam skin 30, the air permeability can be realized throughout the footwear.

According to the present invention, when manufacturing the footwear insole structured as above, the polyurethane resin is foamed and then cut thin so as to be laminating-adhered to the insole foam by using the adhesive. Hereinafter, the manufacturing method as above will be described in detail.

First, the polyurethane foam 10 having the thickness of 4 mm is prepared by a normal method is prepared. After that, the polyurethane resin is prepared using the hydrophilic polyether polyols and 50-95 wt % of the polyurethane resin is mixed with 5-50 wt % of water. After the mixing, the mixture is injected into a mold so as to be foamed and cured for 40-60 minutes, thereby forming the polyurethane foam skin 30.

After that, the polyurethane foam skin 30 is cut thin according to the thickness of the polyurethane foam 10, wherein if the thickness of the polyurethane foam 10 is, for example, 4 mm, the polyurethane foam skin 30 is cut in the thickness of 2 mm.

Next, the normal adhesive 20 is applied between the polyurethane foam 10 and the polyurethane foam skin 10 so as to laminating-adhere the polyurethane foam 10 and the polyurethane foam skin 10 to each other, and then the adhered polyurethane foam 10 and the polyurethane foam skin 10 are cut by using a cutting blade in the shape of the insole, thereby manufacturing the footwear insole to be realized according to the present invention.

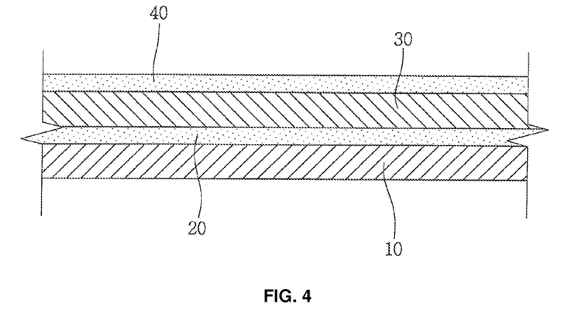

Meanwhile, the polyurethane foam skin 30 is prepared and then adhered to the polyurethane foam 10 according to the present invention as described above, wherein, in order to reinforce the physical properties of the polyurethane foam skin 30, it is also possible to form a polyurethane resin coating layer 40 on the polyurethane foam 10 by coating polyurethane resin in a liquid phase thin, as shown in FIG. 4. Herein, it is also possible to use hydrophilic polyether polyols for producing the polyurethane resin used for such coating.

What is claimed is:

1. A footwear insole made of normal polyurethane foam, characterized in that:
a polyurethane foam skin, which is made using hydrophilic polyether polyols, is adhered to the top surface of the polyurethane foam.

2. The footwear insole according to claim 1, wherein a polyurethane resin coating layer is formed on the surface of the polyurethane foam skin.

3. A method for manufacturing a footwear insole made of normal polyurethane foam, comprising the steps of:
producing polyurethane resin by using hydrophilic polyether polyols and then foaming thus produced polyurethane resin so as to prepare a polyurethane foam skin; and
adhering the polyurethane foam and the polyurethane foam skin to each other by applying an adhesive between the polyurethane foam and the polyurethane foam skin so as to form a footwear insole.

4. The method for manufacturing a footwear insole according to claim 3, comprising the step of, after mixing 50-95 wt % of the polyurethane resin with 5-50 wt % of water, inserting the mixture into a mold so as to foam and then curing the foamed mixture for 40-60 minutes, thereby forming the polyurethane foam skin.
